(19) United States
(12) Patent Application Publication
(10) Pub. No.: US 2009/0202693 A1
(43) Pub. Date: Aug. 13, 2009

(54) Combination saute pan and cooking method

(75) Inventor: Stanley Kin Sui Cheng, Hillsborough, CA (US)

Correspondence Address: MEYER CORPORATION, U.S.;ATTN: EDWARD S. SHERMAN, ESQ., ONE MEYER PLAZA, VALLEJO, CA, 94590, US

(73) Assignee: Meyer Intellectual Properties Limited, Hong Kong (CN)

(21) Appl. No.: 12/367,136

(22) Filed: Feb. 6, 2009

Related U.S. Application Data
(60) Provisional application No. 61/027,654, filed on Feb. 11, 2008.

(51) Int. Cl. A23C 3/037; A47J 27/04

(52) U.S. Cl. 426/474; 220/573.1

(57) ABSTRACT

An article of cookware and a method of using the same are provided that enables the combined sauté and steaming of foods to reduce cooking time, maintain a crisp texture and improve flavors of foods.

### CROSS REFERENCE TO RELATED APPLICATIONS

The present application claims priority to the U.S. Provisional Patent application of the same title filed on Feb. 11, 2008, having application Ser. No. 61/027,654, which is incorporated herein by reference

### BACKGROUND OF INVENTION

The present invention relates to a cookware article and in particular to sauté or fry pan and a method of using the same.

Well known methods of cooking include sautéing in oil, butter or fat, as well as braising in liquid, such as wine, water or stock. While braising does not give food the crisp outer skin of sautéing in a hot oil or fat, it also has the potential to cook faster when the pot is covered, as the braising liquid creates steam that surrounds the food.

Many cooks prefer to sauté food in as little oil as possible, to avoid excessive absorption into food. However, this requires a longer cooking time, which can cause the loss of some vitamins and result in more oil absorption.

It is therefore a first object of the present invention to provide method of cooking that provides a crisp outer texture, but also minimizes cooking time, preserves vitamins and minimizes oil absorption.

It is a second object of the invention to provide cookware articles that accomplish the first object of the invention.

### SUMMARY OF INVENTION

In the present invention, the first object is achieved by a cooking method comprising the steps of providing a cooking vessel having at least a first and second interior fluid retaining portions and a common co-planar bottom being separated by a dividing wall, and a fitted rim for retaining steam therein, introducing a steam producing liquids into the second interior fluid retaining portion, heating the pan, introducing a foodstuff into the first region so that the first side of the foodstuff is heated by conduction from the bottom of the pan, covering the pan with a lid so that the second side of the foodstuff is at least partially cooked by steam generated in the second interior fluid retaining portion.

The above and other objects, effects, features, and advantages of the present invention will become more apparent from the following description of the embodiments thereof taken in conjunction with the accompanying drawings.

### BRIEF DESCRIPTION OF DRAWINGS

FIG. 1A is a plan view of a first embodiment of a cooking pan for combined sauté and steaming of foodstuffs.

FIG. 1B is a perspective view of the pan of FIG. 1A

FIG. 1C is a cross-sectional elevation through pan of FIGS. 1A and 1B including a fitted lid.

FIG. 2A shows the first stage in cooking with the pan of FIG. 1

FIG. 2B shows the next stage of cooking with the pan of FIG. 1.

FIG. 3A is a plan view of second embodiment of the cooking pan for combined sauté and steaming of foodstuffs.

FIG. 3B is a perspective view of the pan of FIG. 3A.

FIG. 3C is a cross-sectional elevation through pan of FIGS. 3A and 3B including a fitted lid.

FIG. 4 is a plan view of a third embodiment of the cooking pan for combined sauté and steaming of foodstuffs.

FIG. 5 is a cross-sectional elevation through a fourth embodiment of the cooking pan for combined sauté and steaming of foodstuffs.

FIG. 6 is a graph comparing the temperature rise in steak cooked with and without the lid in place.

FIG. 7 is a cross-sectional elevation through a fifth embodiment of the cooking pan for combined sauté and steaming of foodstuffs.

### DETAILED DESCRIPTION

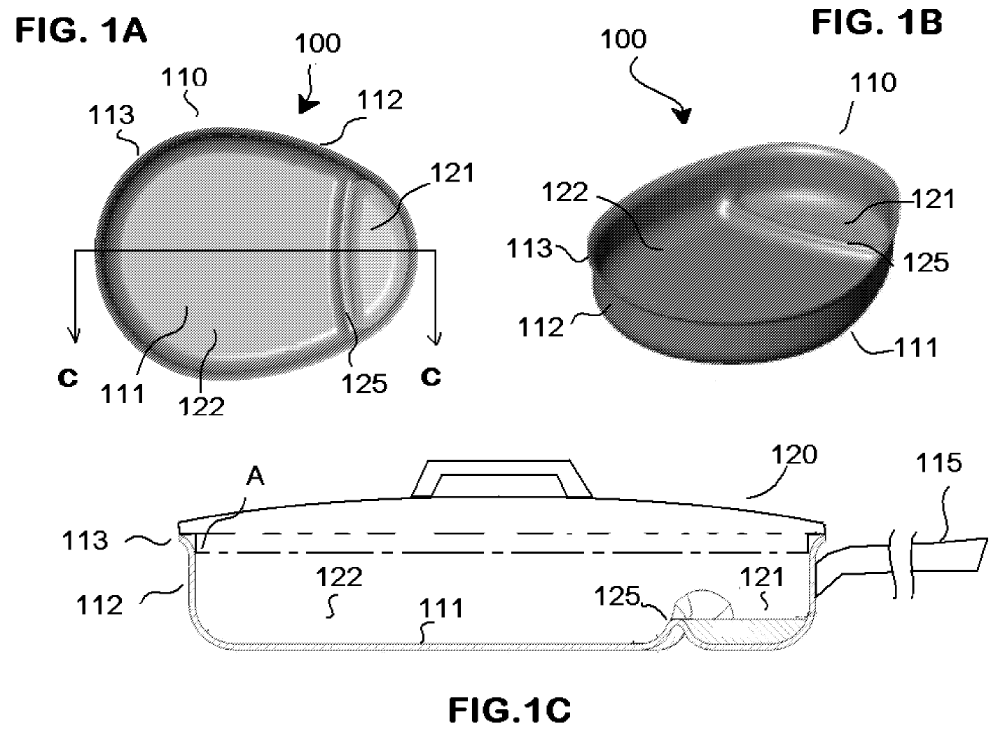

Referring to FIGS. 1 through 7, wherein like reference numerals refer to like components in the various views, there is illustrated therein a new and improved sauté pan, generally denominated 100 herein.

The combination sauté and steam pan 100 comprises a cooking vessel 110 covered by a fitted lid 120. Cooking vessel 110 has a generally horizontal bottom surface 111 and substantially upright side walls 112 that extend to a rim 113. The sidewalls 112 of a sauté pan are optionally sloped to allow for the removal of the cooked food, but are not essential to either the inventive apparatus or the method of use. The cooking vessel 110 has at least one handle 115 that extends outward from the point of attachment to the exterior of sidewall 112. The pan or vessel 110 may contain any combination of a long extended handle 115 as well as one or more short U-shaped handles, depending on the size and weight of the full pan and the resulting need to grip it with two hands from opposite sides.

Cooking vessel 110 has at least two fluid retaining compartments 121 and 122 as shown in FIG. 1-5. The first fluid retaining compartment 121 is separated from the second 122 by a wall 125. Wall 125 is preferably and conveniently formed in the bottom 110 during the deep drawing process to form the vessel 110, or is optionally stamped after drawing. In the former case, the wall 125 separating the first and second interior fluid retaining compartments or portions extends upwards to subdivide the common co-planar bottom into discontinuous portions. However, the wall 125 and the separate fluid retaining compartments can be formed by any process used to form cookware, and is not limited to all metal cookware, but can be used with glass, ceramic, clad, cast iron and coated cast iron cookware according to the preference of the end user.

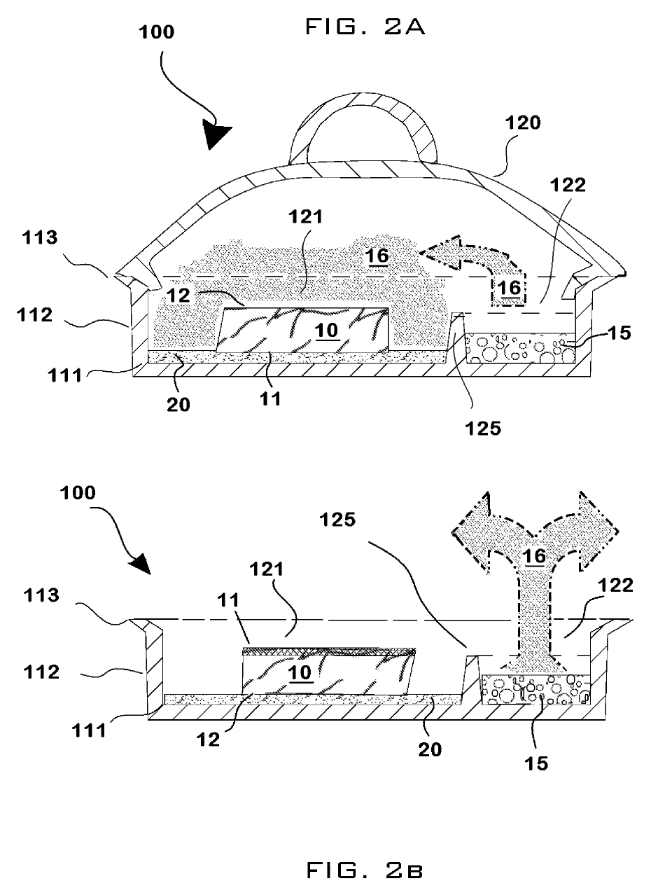

It should first be understood that as the purpose of having two separate fluid retaining compartments 121 and 122 is to cook foodstuffs 10 by a combination of conduction of heat directly from the heated pan bottom 111 in portion 121 or 122, and/or via a layer or film of oil, fat or butter 20, and simultaneously cook the other exposed portion of the meat by the convection from steam generated from liquid retained in the other portion, it is important that a well fitting lid 120 be included and used with the pan 100. As illustrated in FIGS. 2A and 2B, the steam 16 is readily generated during cooking by filling the second compartment 122 with water containing fluid 15.

Thus it is desirable that the wall 125 is below the level of the interior rim 113 so as to not interfere with the sealing of the lid 120 to the pan 110. However, it is more preferable that the lid 120 has a lower descending skirt 127 that extends to at least meet the interior wall 112 below the rim 113 at or below point A in FIG. 1C to minimize the release of steam and exploit the benefits of the cooking methods further described further below.

The vessel 110 preferably has an irregular shape to accommodate the second fluid containing chamber 122 and not diminish the area required for cooking the food in portion 121. However, many suitable shapes are possible both to satisfy the technical requirements described herein for the cooking method, as well as to provide consumers with aesthetically pleasing designs.

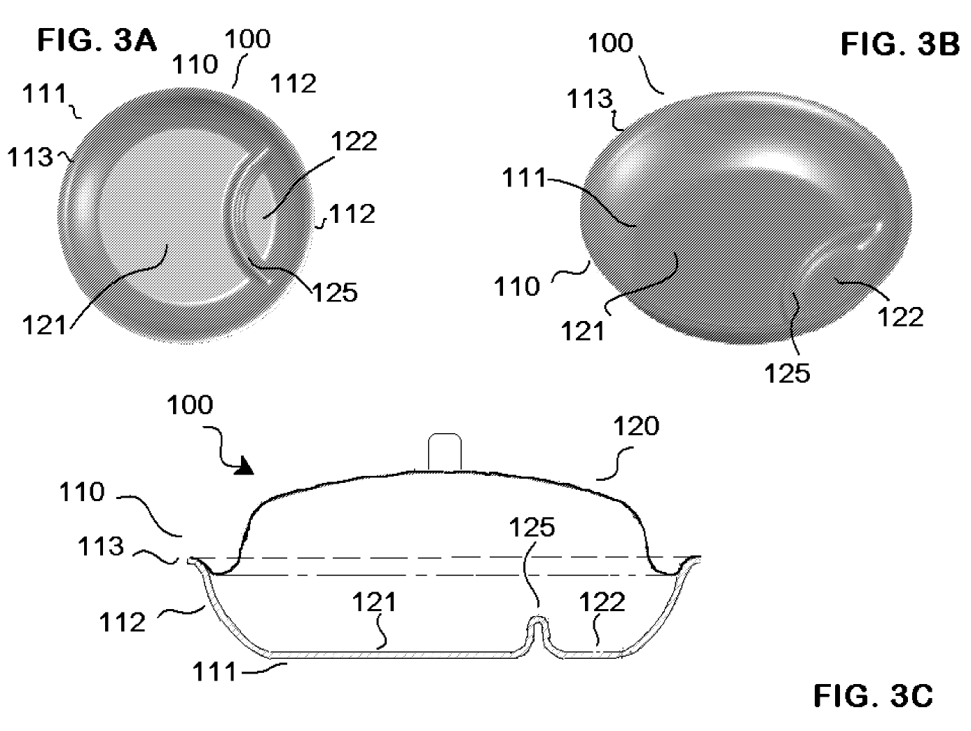

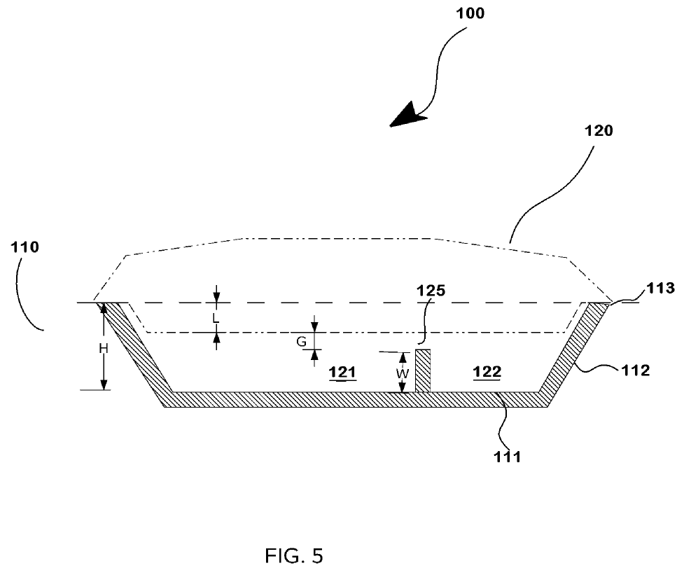

One such preferred pan shape is the oblong or egg shape of FIG. 1. However, the rounded shape shown in FIG. 3 is also applicable, as well as the oval shape in FIG. 5.

It should be noted that rounded shape with the second fluid containing portion disposed to the edge of the elongated side as shown in FIG. 1.

FIGS. 2A and 2B exhibit a preferred embodiment of a method of using the sauté pan 110 to cook.

In the first step, in FIG. 2A, cooking oil 20 is introduced into first 121 or larger of the two fluid containing compartments. The cooking oil 20 is optionally butter, vegetable oil or fat and the like which can be heated to a high enough temperature to sear or brown the outside of foodstuffs, thus providing a crisp skin that seals in the natural liquid content of the foodstuff 10. When the oil 20 is hot the foodstuff 10 is added to the oil coated bottom of the pan in portion 121. At the same time water 15 or a water containing fluid, such as wine or broth, is added to the second or smaller fluid containing portion 122 and the lid 120 is set on the pan 110. Thus, while the foodstuff 10 is cooking in the first compartment 121, the fluid 15 in the second compartment 122 will also be heated generating steam 16. FIG. 2A illustrates how the steam 16 generated above container 122 disperses under the fitted lid 120 to surround the foodstuff. The oil 20 does not splatter, as the steam does not condense but remains circulating under the lid.

Thus, while the foodstuff 10 is cooked on the first side 11, the surrounding steam will aid in the cooking of the second side 12 and the vertical edge between the first 11 and second side 12. Depending on the type, density and thickness of the food it may not be necessary to flip it over, or the lid may be left in place after flipping the food.

Alternatively, depending on the foodstuff being cooked, the lid may remain on the pan 110 while the first and second sides of the food stuff 10 are cooked in direct contact with the pan bottom 111 and oil or fat 20 in the first portion 122. It has been discovered that one benefit of the cooking method enabled by the pan and lid combination is the reduction in cooking time. The cooking time may be reduced by about 10-40% using the above methods, with greater reduction in cooking time being available when the lid covers the pan for the entire cooking time.

Optionally, the lid 120 can be removed after the food stuff 10 is turned over, as shown in FIG. 2B, so that side 11 first browned or crisped in oil 20 now faces upward. Removing the lid allows the steam 16 to escape upward, which may be preferred when the second side is cooked in contact with the oil 20 in the first portion 121, so that the steam does not make the already crisp and flavorful side soggy.

It has been discovered that this method of cooking results in more flavorful foods with a pleasing external texture at cooking times that are reduced by at least a third or more. Further, less oil if desired for fast cooking or texture can be used in cooking. It is further believed that the cooking method will result in the retention in a higher percentage of the vitamins in food, as the cooking time is shorter and not all of the food is exposed to very high temperature.

In another embodiment of the invention, the fluid 15 used in the second compartment 122 is or optionally contains wine, beer, sakes, broth, juice and the like. The liquid in the second compartment may also contain other flavoring ingredients, such a Liquid Smoke™, herbs, spices and prepared commercial condiments and the like.

In the case of water, or any of the alternative fluids being used in the second compartment 122, the remaining liquid at the end of cooking foodstuff 10 may be used to deglaze the pan at the end of cooking to create a thick sauce. In the case of wine, a flavorful and alcohol free reduction is conveniently created in portion 122 without using a second cookware article.

FIG. 3A-C illustrates a round pan with a generally elliptical second portion or compartment 122 to the side. The handle may be situated on any side, but is preferably adjacent to the second compartment 122, so that the absorption of heat to boil water 15 results in a cooler handle 115, which is shown only in FIG. 3C.

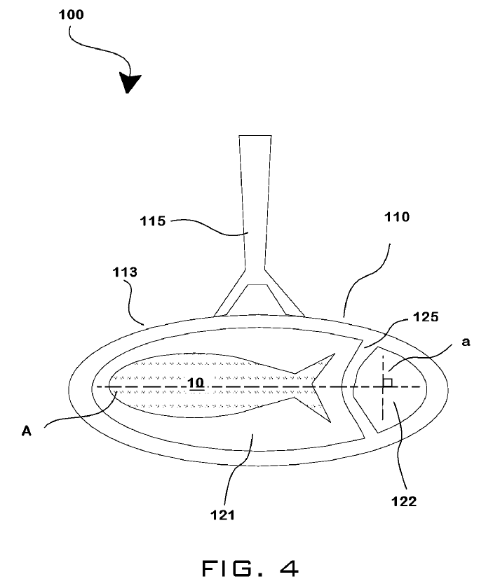

For any round wall shape it is generally preferable the wall 125 that defines the second fluid 122 containing portion is curved with the opposite curvature of the adjacent pan wall to provide a sufficient fluid volume without overly diminishing the area of the other or main cooking portion 122. FIG. 4 particularly illustrates this design principle with an oblong or elliptical pan, with principal elliptical axis A₁. Such a pan shape is particularly suited for cooking whole fish or large fish fillets. The larger compartment or portion 121 has the general elliptical or oval shape except for the small edge reserved for the second compartment 122, which is situated at the apex of the ellipse longer axis A. Thus, the second fluid containing compartment 122 also has an elliptical shape with its long axis, a₂, perpendicular to axis A₁ of compartment 121. The handle 115 extends outward from the sidewall of the pan along the short axis B₂ of the ellipse of the main pan body.

It is particularly preferred that the lid 120 has an interior downward extending flange or skirt 127 that matches the interior sidewall shape of the pan 110 to retain steam 16. In the more preferred embodiment of FIG. 1, this flange is inset slightly from the exterior edge of the rim, so that the interior edge of the lid rests on the upper surface of rim 113.

FIG. 5 illustrates preferred proportions for the lid flange 127 with respect to the pan 110 interior and exterior dimensions, wherein H is the interior height of the pan 110, L is the length of the lid skirt 127, G is the gap between the wall 125 (which has height W), and the lid skirt 127. It should be apparent that G=H−W−L. Thus, for the lid 120 to fit pan 112 G must be a positive number. The larger the height W of the wall 125 the more diminished is the room for the lid skirt 127 to extend downward, L, to aid in the retention of steam. However, making W smaller reduces the volume of the second container or portion 122.

Further it is preferable that W is at least about H/2 and that L is at least about H/4 so that G is less than about H/4. These relative proportions of the lid skirt 127 length L, to the wall height, H, provide a sufficient flux of steam into first container portion 121. Making the gap, G, close to zero maximizes steam retention and the fluid capacity for generating steam.

Alternatively, depending on the height of the lid 120 above rim 113, L can be about the same as W, with L being less than about H/4.

It is also desirable that the lid 120 is transparent glass to observe the cooking process. It is most preferable if the lid has an interior coated with a surface coating that minimizes condensation of water vapor.

It should also be apparent that the lid 120 and rim 113 may be shaped or provided in different forms that aid in the retention of steam, as for example the rim 113 may have a concave horizontal surface into which a mating convex surface of the lid 120 is disposed so as to trap condensation as a water film that tends to seal the mating surfaces together for so called “waterless” cookware. Alternatively, the lid may include a gasket to retain pressure as in the case of a pressure cooker, with adequate means provided to release pressured steam safely and prevent injury in accord with current and future standards for pressure cookers.

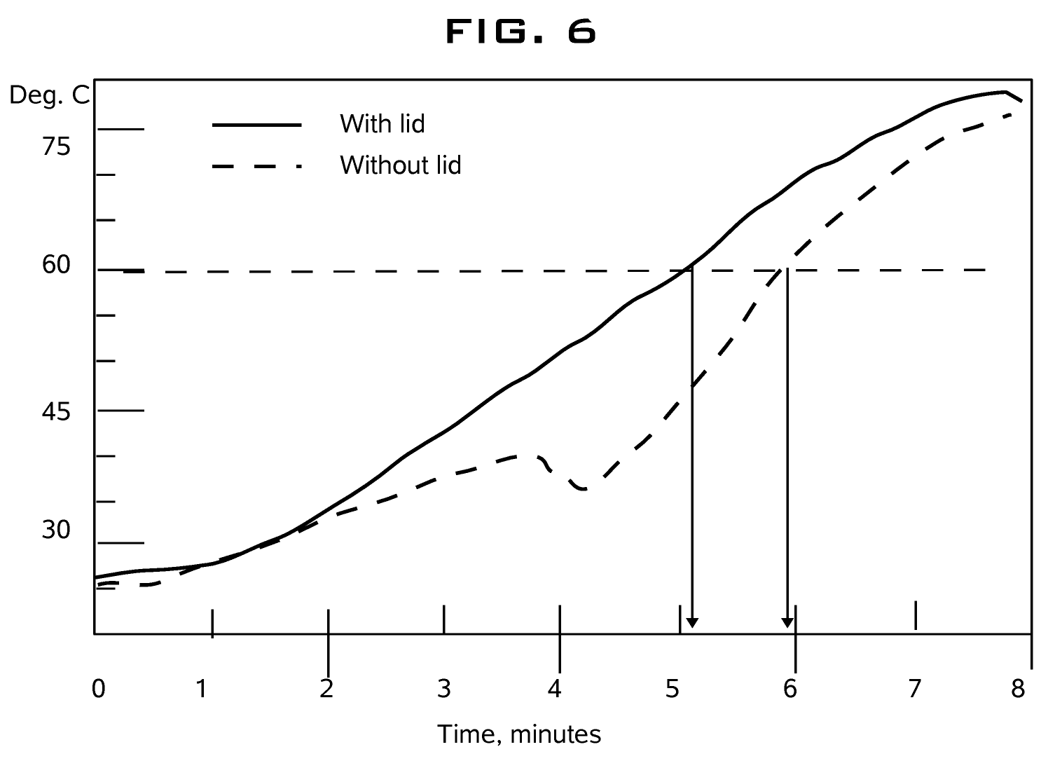

The benefits of the present invention are illustrated in FIG. 6, which compares the rise in temperature during cooking with and without the lid in place. In this test steaks of approximately 1.1 inch in thickness (28 mm) where cooked in the pan of the type shown in FIG. 1-5, using a hot plate set at 2 KW output as the heat source. The pan was first preheated on the hot plate for 2 min. Then the steak, having thermocouples in the center for continuous recoding of temperate, was introduced into the pan. After 4 minutes of cooking the steak on the first side it was flipped to cook the second side. It should be noted that in both cases the cup portion of the pan was filled to capacity with about 50 ml of water prior to the preheating. The water was already visibly boiling when the steak was added after 2 minutes. As shown in FIG. 6 by the arrowed lines descending from the coordinate where the temperature curves reached 60° C., about a minute reduction in cooking time was achieved when the lid was in place for booth sides of the steak. The steak with the lid in place reached 60° C. at its center in about 5 minutes, versus about 6 minutes without the lid.

It should be appreciated that as the slope of the curves in FIG. 6 vary between about 3-7 minutes, a greater or less decrease in cooking time can be achieved depending on the thickness and nature of the foodstuff, as well as the cooks criteria or taste in deciding when the food is cooked.

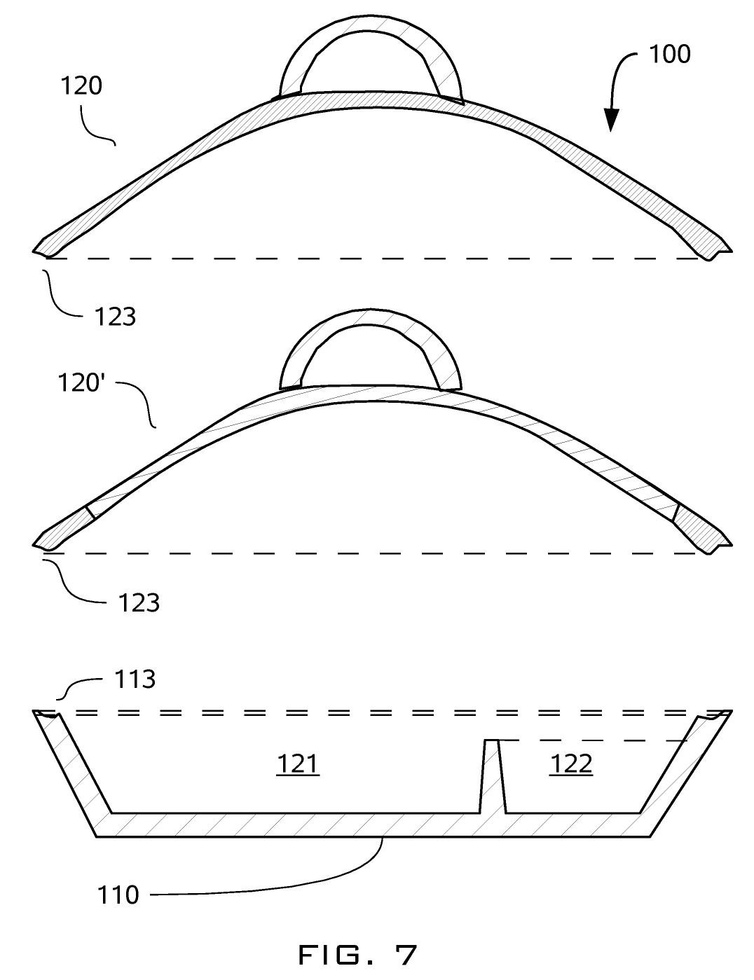

FIG. 7 illustrates another alternative embodiment of the invention wherein cookware vessel 110 includes a lid 120 or 120′. Lid 120′ has a glass central portion, terminating in a metal periphery at rim 123′. Lid 120 is solid metal and also terminates at rim 123. Lid 120 has lower peripheral rim 123 (or 123) which mates with the rim of a complimentary shape rim 113 on the vessel 110. Rims 123 and 123′ are curved to be slightly concave over at least a portion of the surface to condense and trap a thin water layer as a vapor seal to hold in steam at low pressures for so called “waterless cooking”.

More preferably lid is transparent glass, having a central glass portion for visibility into pan during cooking, with a metal periphery that forms the lower mating surface on lid for attaching to the rim.

While the invention has been described in connection with a preferred embodiment, it is not intended to limit the scope of the invention to the particular form set forth, but on the contrary, it is intended to cover such alternatives, modifications, and equivalents as may be within the spirit and scope of the invention as defined by the appended claims.

1. A method of cooking in a lidded pan, the method comprising the steps of:
a) providing a cooking vessel having at least a first and second interior fluid retaining portions and a common co-planar bottom being separated by a dividing wall, and a fitted rim for retaining steam therein,
b) introducing a steam producing liquids into the second interior fluid retaining portion,
c) heating the pan,
d) introducing a foodstuff into the first region so that the first side of the foodstuff is heated by conduction from the bottom of the pan,
e) covering the pan with a lid so that the second side of the foodstuff is at least partially cooked by steam generated in the second interior fluid retaining portion.

2. A method of cooking in a lidded pan according to claim 1, wherein said step of heating the pan occurs before said step of introducing a steam producing liquid.

3. A method of cooking in a lidded pan according to claim 2, furthering comprising the steps of:
a) removing the lid, and
b) inverting the foodstuff in the first region to cook the second side thereof.

4. A method of cooking in a lidded pan according to claim 3, furthering comprising the step of covering the pan with the lid after said step of inverting the foodstuff.

5. A method of cooking in a lidded pan according to claim 1, wherein the lidded pan has a generally oval shape.

6. A method of cooking in a lidded pan according to claim 5, wherein at least one of the first and second interior fluid retaining portions of the lidded pan have at least one side in common with the edge of the pan.

7. A method of cooking in a lidded pan according to claim 5, wherein the first and second interior fluid retaining portions of the lidded pan have at least one side in common with the edge of the pan.

8. A method of cooking in a lidded pan according to claim 6, wherein the first and second interior fluid retaining portions of the lidded pan have a substantially oval shape, and the principal axis of at least one of the first and second interior fluid retaining portions is substantially perpendicular to the principal axis of the oval pan.

9. A method of cooking in a lidded pan according to claim 1, wherein the lid of the lidded pan has at least a transparent glass portion.

10. A method of cooking in a lidded pan according to claim 1, wherein the lidded pan and the lid thereof have complimentary matting rims, the rim of the pan having a concave shape for trapping condensed water between the rim of the lid.

11. A method of cooking in a lidded pan according to claim 1, wherein the smaller of the first and second interior fluid retaining portions of the lidded pan retains the liquid and is adjacent the side of the pan and the pan further comprises a handle extending outward from the side of the pan containing the liquid.

12. A method of cooking in a lidded pan according to claim 1 wherein the dividing wall separating the first and second interior fluid retaining portions extends upwards to subdivide the common co-planar bottom into discontinuous portions.

13. A method of cooking in a lidded pan according to claim 1, wherein the steam producing liquid is wine.

14. A method of cooking in a lidded pan according to claim 13, wherein the method of cooking produces a concentrated wine sauce in the second interior fluid retaining portion.

15. A method of cooking in a lidded pan according to claim 1, wherein the steam producing liquid is selected from the group consisting of wine, beer, sakes, broth, juice and flavored or spiced liquids.

16. A method of cooking in a lidded pan, the method comprising the steps of:
a) providing a cooking vessel having at least a first and second interior fluid retaining portions and a common co-planar bottom being separated by a dividing wall, and a fitted rim for retaining steam therein,
b) introducing at least one of wine and an alcoholic flavoring beverage into the second interior fluid retaining portion,
c) heating the pan,
d) introducing a foodstuff into the first region so that the first side of the foodstuff is heated by conduction from the bottom of the pan whereby at least a portion of the evaporable components of the at least one of wine and an alcoholic flavoring beverage in the second interior fluid retaining portion is evaporated to concentrate the fluid to form a flavoring sauce.

17. A method of cooking in a lidded pan according to claim 16, wherein said step of heating the pan occurs before said step of introducing at least one of wine and an alcoholic flavoring beverage into the second interior fluid retaining portion.

18. A cooking vessel comprising;
a) A fluid containing vessel having a bottom and surrounding sidewalls upright extending substantially upward there from to terminate in a first rim, wherein the fluid containing chamber is divided into at least a first and second interior fluid retaining portions and a common co-planar bottom being separated by a dividing wall, wherein the second fluid retaining portion is adjacent the side of the vessel,
b) and a fitted lid having a lower rim for matted engagement with the first rim of the vessel for retaining steam in the fluid containing vessel, wherein the dividing wall is disposed below the lower rim of the lid at the junction with the upright sidewall.

19. A cooking vessel according to claim 18 wherein the first rim of the vessel and the lower rim of the rim have complimentary matting shapes, with the first rim of the having a concave shape for trapping condensed water between the lower rim of the lid.

20. A cooking vessel according to claim 18 wherein the vessel further comprises a handle extending outward from the side of the adjacent the second interior fluid retaining portions.
